(19) United States
(12) Patent Application Publication
(10) Pub. No.: US 2010/0207715 A1
(43) Pub. Date: Aug. 19, 2010

(54) CHOKE INTEGRATED INTO A PRINTED CIRCUIT

(75) Inventor: Marc Pouplier, Cosnac (FR)

Correspondence Address: STROOCK & STROOCK & LAVAN LLP, 180 MAIDEN LANE, NEW YORK, NY, 10038, US

(73) Assignee: Thales, Neuilly Sur Seine (FR)

(21) Appl. No.: 12/444,271

(22) PCT Filed: Oct. 5, 2007
(86) PCT No.: PCT/EP2007/060618

§ 371 Date: Apr. 30, 2010

(30) Foreign Application Priority Data
Oct. 6, 2006 (FR) 0608793

(51) Int. Cl. H01F 5/00

(52) U.S. Cl. 336/200

(57) ABSTRACT

Choke printed on a material of thickness H, the choke including one or more turns characterized in that a turn includes a first metallized track deposited on a first face of the material, of a second metallized track deposited on a second face of the material, a track deposited on the first face being united with a track deposited on the second face by means of at least one metallized hole passing through the thickness of the material.

### CROSS-REFERENCE TO PRIOR APPLICATION

This is a U.S. National Phase Application under 35 U.S.C. §371 of International Application No. PCT/EP2007/060618, filed on Oct. 5, 2007, and claims benefit of French Patent Application No. 0608793, filed on Oct. 6, 2006, both of which are incorporated herein. The International Application was published in French on Apr. 10, 2008 as WO 2008/040814 under PCT Article 21 (2).

### BACKGROUND OF THE INVENTION

1. Field of the Invention

The invention relates notably to a three-dimensional choke made on a printed circuit.

It can also relate to any choke having to be made in a circuit including a material exhibiting a certain thickness, each face of this material including metallized tracks. The material is for example a microwave material. It can be used in respect of the filters for radio communication equipment.

2. Description of the Prior Art

When designing specific and high-performance filters, it is usually necessary to make air-core choke coils which are wound on a specific mandrel. The direction of the winding, the volume of the choke and the gauge of the wire are chosen as a function of the requirement.

This mode of fabrication requires a very high precision in the fabrication of the specific choke. It is necessary to have a high precision in the mandrel supporting the winding and therefore to resolve any mechanical problem that might exist. Moreover, the diameter of the wire which will be coiled around the mandrel must be perfectly controlled, the tension on the wire must be constant at the time of coiling and finally the whole is fastened or molded so as to avoid any subsequent deformation.

In general the procedures known in the prior art require adjustments which lead to various drawbacks, for example, an increase in the number of components, degraded reliability, cost related to its fabrication and to the adjustment time.

The idea of the present invention is to make the chokes, notably tuning chokes in the case of filters, directly on a printed circuit.

### SUMMARY OF THE INVENTION

An embodiment of the invention relates to a choke printed on a material of thickness H, the choke including one or more turns wherein a turn includes a first metallized track deposited on a first face of the material, of a second metallized track deposited on a second face of the material, a track deposited on the first face being united with a track deposited on the second face by means of at least one metallized hole passing through the thickness H of the material.

### ADVANTAGES OF THE INVENTION

The method according to an embodiment of the invention presents notably the following advantages:
High reproducibility in the values of the chokes,
Of fixing its environment (of controlling the magnetic couplings, of all the stray elements),
Of benefiting from the precision of the printed circuit technique,
Of circumventing wiring problems,
Of obtaining quality factors that are high,
Of making choke “clones” simply (significant advantage for certain applications: filters notably).

### BRIEF DESCRIPTION OF THE DRAWINGS

Other characteristics and advantages of the present invention will be more apparent on reading the description which follows of an exemplary embodiment given by way of wholly nonlimiting illustration in conjunction with the appended figures which represent:

FIG. 1 an overall view of a choke made on a printed circuit,

FIG. 2 a diagram representative of a printed choke,

FIG. 3 an exemplary layout of a tractable filter, and

FIG. 4 another exemplary layout of a tractable filter.

### DETAILED DESCRIPTION OF THE PREFERRED EMBODIMENT

In order to better elucidate the subject of the present invention, the description which follows is given by way of nonlimiting illustration for a choke made on a printed circuit and able to serve as tuning choke for a filter.

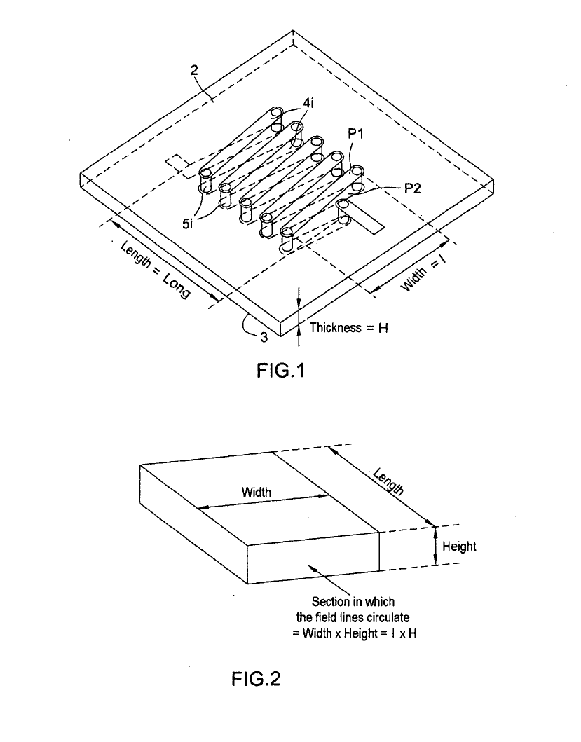

Represented in FIG. 1 is an overall view of a printed circuit 1 including a microwave material and including a first face 2 or lower face, a second face 3 or upper face. The printed circuit possesses a thickness e corresponding substantially to the height H of a turn such as detailed hereinafter. On each of the faces 2, 3 are deposited one or more metallized tracks 4i constituted, for example of copper coated with gold. The tuning chokes are made directly on a printed circuit and in the case of the present exemplary application, the tracks 4i on the two exterior faces are linked together by metallized orifices 5i, usually dubbed vias, the whole assembly producing turns of rectangular section such as are represented in this FIG. 1.

The turns are three-dimensional. The following criteria are complied with:
the width of the tracks is chosen so as to comply with conduction due to the skin effect,
the dimensions of the vias are determined so as to comply with conduction due to the skin effect,
the separation of the tracks is chosen so as to minimize the inter-turn capacitance.

The value of the choke thus constituted depends notably on the following parameters; the thickness of the printed circuit, the number of track (equivalent turn), the physical aspect of the tracks (length, width, inclination, for example).

The quality factor Q of the choke depends notably:
on the physical dimensions of the whole assembly (length, width, thickness). This is the physical shape factor. A cubic shape gives the best Q,
on the separation between tracks (equivalent stray capacitance between turns for an air-core choke according to the prior art),
on the surface treatment of the tracks (electro-chemical gold plating or any equivalent treatment),
on the physical and electrical magnitude of the through-vias (diameter of the holes and thickness of metallization copper),
on the proximity of the ground planes and shielding.

FIG. 2 represents a diagram of a choke printed, according to an embodiment of the invention. The choke is characterized by a width I, a length Long and a height H corresponding to the thickness of the printed circuit. The assembly Length, width I and height H forms a section of a turn in which the field lines=width*height circulate.

It is assumed that the rectangular section in which the field lines circulate may be regarded as a circular section. From the rectangular section, the diameter of the circular equivalent section is deduced:

Dequi=2*√(I*H/π)

The value of the printed chokes is determined using Dequi in PIAT's formula known to the Person skilled in the art, which leads to:

L(nH)=100[(D_{equi}*N²)/(40+(110*Long/D_{equi}))]

i.e.:

L(nH)=100[(2*√(I*H/π)*N²)/(40+(110*Long/2*√(I*H/π)))]

With N the number of turns, Long=the length of the choke, I=width and H=the thickness of the printed circuit.

The parameters length, width, thickness of the material (or height of the turn) as well as the number N of turns are dimensioned as a function of the intended application.

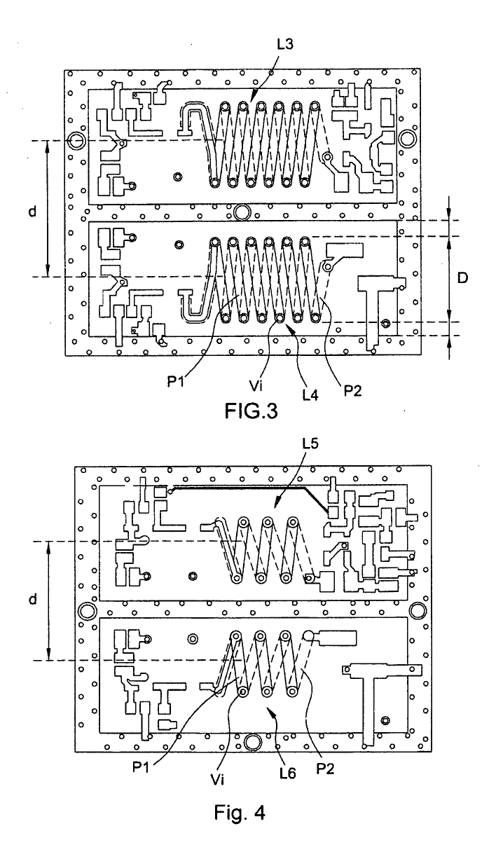

FIGS. 3 and 4 represent two variant embodiments according to the invention relating to two tractable filters covering different frequency ranges, each with their two identical but oppositely wound chokes integrated into the printed circuit. The value of the choke is suited to the requirements.

In FIG. 3 the chokes L3 and L4 are symmetric, with oppositely directed winding. The distance d between the mid-lines of the chokes is chosen so as to comply with the magnetic coupling. In the same manner, the position of the vias with respect to the ground lines of the integrated circuit will be complied with so as to avoid or minimize the stray capacitances while complying with the control of the gap between the grounds.

In a similar manner to what was described above,
the width of the tracks is chosen so as to comply with conduction due to the skin effect,
the dimensions of the vias are determined so as to comply with conduction due to the skin effect,
the separation of the tracks is chosen so as to minimize the inter-turn capacitance.

The reference P1 corresponds to a track deposited on the upper face of the material, the reference P2 on the lower face of the material and Vi the vias or metallized holes.

FIG. 4 represents another variant embodiment for which the chokes L5 and L6 are oppositely wound with values suited to the requirements of the application.

1. A choke printed on a material having a first face, a second face substantially opposite from the first face, and a thickness H, the choke comprising one or more turns connected in series, wherein at least one turn comprises a first metalized track deposited on the first face of the material, a second metalized track deposited on the second face of the material, and at least one metallized hole passing through the material, the metalized hole electrically connecting the first metalized track with the second metalized track.

2. The printed choke as claimed in claim 1, wherein a turn includes a rectangular section.

3. The printed choke as claimed in claim 1, wherein the inductance value of the choke is determined in accordance with the following relationship:
L(nH)=100[(D_{equi}*N²)/(40+(110*Long/D_{equi}))]
wherein:
D_{equi}=2*√(I*H/π);
I=width of a turn;
Long=length of a turn;
H=thickness of the material;
N=number of turns of the printed choke; and
L=inductance, in nano-Henries.
